(19) United States
(12) Patent Application Publication
(10) Pub. No.: US 2014/0214706 A1
(43) Pub. Date: Jul. 31, 2014

(54) SOCIAL NETWORKING-BASED PROFILING

(71) Applicant: Yang-Won Jung, Seoul (KR)

(72) Inventor: Yang-Won Jung, Seoul (KR)

(73) Assignee: EMPIRE TECHNOLOGY DEVELOPMENT LLC, Wilmington, DE (US)

(21) Appl. No.: 13/809,305

(22) PCT Filed: Jul. 27, 2012
(86) PCT No.: PCT/US12/48576

§ 371 Date: Jan. 9, 2013

(51) Int. Cl. G06Q 10/10; G06Q 50/00

(52) U.S. Cl. CPC G06Q 10/1053; G06Q 50/01
USPC 705/319

(57) ABSTRACT

In one example, a computer-readable medium stores computer-executable instructions that cause one or more processors to aggregate at least a subset of a listing of current employees into at least one of plural categories, scan online activity for one or more of the current employees to an online service to detect instances of predetermined indicia, and collect the detected instances of the predetermined indicia into a profile for a perspective employee.

### TECHNICAL FIELD

The embodiments described herein pertain generally to utilizing social networking to find commonality among high-achievers, and exploiting the resulting knowledge for corporate purposes.

### BACKGROUND

Social networking services are ubiquitous in the Internet culture. Participants in these services reveal much of themselves online, intentionally or not. Stories abound of corporate human resource departments attempting to exploit knowledge of job applicants that is available via social networking services, though there has been backlash against such practices amidst concerns of invasions of privacy and loss of freedom of such, both treasured rights in certain societies.

### SUMMARY

In one example embodiment, a computer-readable medium stores computer-executable instructions that, when executed, cause one or more processors to aggregate at least a subset of a listing of current employees into at least one of plural categories, scan online activity for one or more of the current employees to an online service to detect instances of predetermined indicia, and collect the detected instances of the predetermined indicia into a profile for a perspective employee.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 shows an example system configuration in which social networking-based profiling may be implemented, arranged in accordance with at least some embodiments described herein;

FIG. 2 shows the system of FIG. 1, which includes an example configuration of a monitoring entity that is configured to implement social networking-based profiling, arranged in accordance with at least some embodiments described herein;

FIG. 3 shows the system of FIG. 1, which includes an example configuration of a processing flow of operations for social networking-based profiling implemented by, at least, a monitoring entity, arranged in accordance with at least some embodiments described herein;

FIG. 4 shows an example configuration of a profile resulting from at least some of the embodiments of social networking-based profiling described herein; and

FIG. 5 shows a block diagram illustrating an example computing device by which various example solutions described herein may be implemented, arranged in accordance with at least some embodiments described herein.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

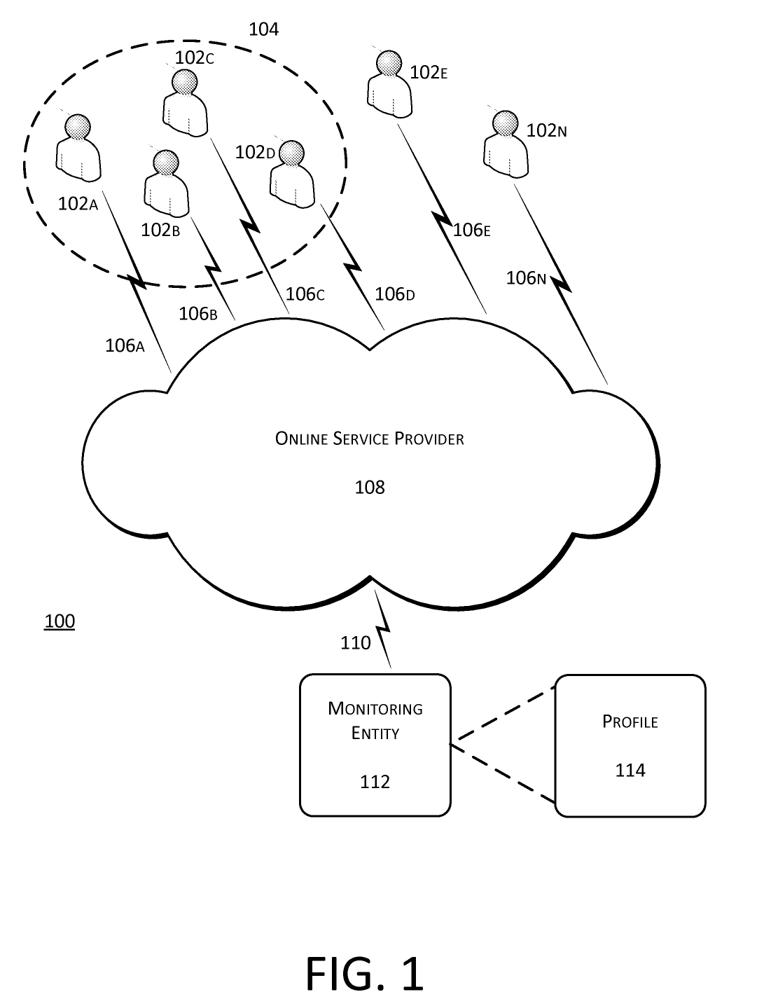

FIG. 1 shows an example system configuration 100 in which social networking-based profiling may be implemented, arranged in accordance with at least some embodiments described herein. As depicted, configuration 100 includes, at least, employees 102A, 102B, 102C, . . . 102N, who may be referenced collectively as “employees 102,” unless otherwise stated herein; a subset 104 of employees 102; an online service provider 108; a monitoring entity 112; and a resulting profile 114.

Employees 102 may refer to individuals who are employed by a business entity (not shown), which may be referred to herein as Company X. Employees 102 may be currently employed by Company X (current employees), previously employed by Company X (former employees), or otherwise contractually sourced to or from Company X. Regardless of which of the foregoing employment statuses applies to any one of employees 102, relative to Company X, it is not necessary for each of the respective employees 102 to have authorized Company X to access his/her personal online activity on one or more social networking services in order to implement social networking-based profiling as described herein by a human resources department within or contracted by Company X.

Subset 104 may refer to a subset of a listing of current employees 102. Subset 104 may be aggregated on the basis of one or more categorizations that include, but certainly are not limited to: participation on one or more particular online services, e.g., social networking services; department within Company X; job title within Company X; job description within Company X; skill set utilized at Company X; years of employment at Company X; etc. Further, within each of the aforementioned examples of categories, subset 104 may include high achieving or highly rated employees therein. Thus, social networking-based profiling may glean characteristics and/or traits to produce more efficient job descriptions leading to execution of a more efficient employee search process.

Transmissions 106 may refer to communication links enabled by a protocol utilized to transmit data and/or information between a device owned and/or controlled by a respective one of employees 102 and online service provider 108. In this regard, the aforementioned protocol may include any mobile communications technology, e.g., GSM, CDMA, etc., depending upon the technologies supported by particular wireless service providers to whose services employees 106 may be assigned or subscribed. Further, one or more of transmissions 106 may be implemented utilizing non-cellular technologies such as conventional analog AM or FM radio, Wi-Fi™, wireless local area network (WLAN or IEEE 802.11), WiMAX™ (Worldwide Interoperability for Microwave Access), Bluetooth™, hard-wired connections, e.g., cable, phone lines, and other analog and digital wireless voice and data transmission technologies.

Transmissions 106 may also refer to the activity of a respective one of employees 102 on the social networking service hosted by online service provider 108. In other words, transmissions 106 may refer to the exchange of substantive data between a respective one of employees 102 and online service provider 108.

The data exchanged between a respective one of employees 102 and the social networking service hosted by online service provider 108 represents that employee's online activity on the service. Such activity may include, as non-limiting examples: various aspects from a profile provided by the respective one of employees 106, including but not limited to age, date of birth, location of birth, places of education, educational degrees attained, places lived, political preferences, hobbies, family status, status of family members, etc.; comments posted, regardless of context, on a personal page or on that of another participant to the online service; photographs, videos, and/or audio files posted to a personal page or on that of another participant to the online service; media read, viewed and/or listened to when linked on the personal page of another participant to the online service; websites, corporate entities, activities, political/entertainment personalities, events, etc., for which a strong preference/favoritism has been noted a personal page or on that of another participant to the online service; online connections with one or more other participants to the online service; etc.

Transmission 106, regardless of its form, may originate from an electronic device on which an instance of an application for the online service or a browser that is connected or otherwise coupled to a website for the online service may be hosted to implement at least portions of social networking-based profiling. Further, the electronic device may be configured to transmit and receive data over a radio link to online service provider 108 by further connecting to a mobile communications network provided by a wireless service provider (not shown). The device may be implemented as a mobile (or portable) electronic device such as a mobile phone, cell phone, smartphone, personal data assistant (PDA), a personal media player device, an application specific device, or a hybrid device that includes any of the above functions. The device may also be implemented as a personal computer including tablet, laptop computer, and non-laptop computer configurations, which may be connected to the aforementioned mobile communications network or, alternatively, to a wired network.

With the foregoing in mind, alternative embodiments of social networking-based profiling may contemplate Company X, via monitoring entity 112, also receiving transmissions 106, either directly or indirectly via online service provider 108.

Online service provider 108 may be regarded as a cloud-based service and storage platform owned and/or operated by a third-party service provider. Service provider 108 may include a framework of hardware, software, firmware, or any combination thereof, through which or to which digital data and information may be stored, passed, or shared with regard to a transaction for which at least one subscriber to the hosted service, including employees 102, is a party. Non-limiting examples of such online services, e.g., social networking services, include Facebook®, Twitter®, Instagram®, Flickr®, Tumblr®, Foursquare®, LinkedIn®, etc.

Transmission 110 may refer to a communication link enabled by a protocol utilized to transmit data and/or information between online service provider 108 and monitoring entity 112, which may include a server owned, controlled by, and/or contracted to Company X or a contracted partner.

Alternatively, transmission 110 may include at least portions of the substantive data, i.e., activity, included in transmissions 106.

Monitoring entity 112 may refer to an entity, including but not limited to a server, which may be owned, controlled by, and/or contracted to Company X or a contracted partner. Monitoring entity 112 may include a server, series of servers, or other processing device that run a software application or other form of computer program product that is configured, designed, or programmed to monitor the activity for one or more of employees 102, detect instances of predetermined indicia, collect the detected instances of the predetermined indicia, and collate the indicia into a profile 114 for a perspective employee for Company X.

Monitoring entity 112 may monitor the activity of a particular one of employees 102 or those of employees 102 within subset 104. Further, as monitoring entity 112 monitors such activity, instances of predetermined indicia may be compiled for inclusion in profile 114. A lack of activity, or even a refusal to authorize such monitoring, may be monitored by monitoring entity 112. Regardless, the indicia may include one or more keywords that are indicative of job-related performance, as gleaned from psychological profiles for subjects belonging to one or more of a particular, department, job title, job description, skill set, etc., whether affiliated with Company X or not. Even further, the indicia may be applicable to high achievers within one or more of the aforementioned categories. That is, the indicia may be based on studies, either internal or external to Company X, for at least the one or more categorizations upon which subset 104 of employees 102 is based.

Profile 114 may refer to a collated compilation of the compiled indicia that cross-reference the categorizations upon which subset 104 of employees 102 is based against detected instances of predetermined indicia found in the monitored activity of subset 104 of employees 102 on, at least, the service hosted by online service provider 108.

FIG. 1, therefore, provides an overview of a system for implementing social networking-based profiling, which may be leveraged for corporate purposes, i.e., human resources.

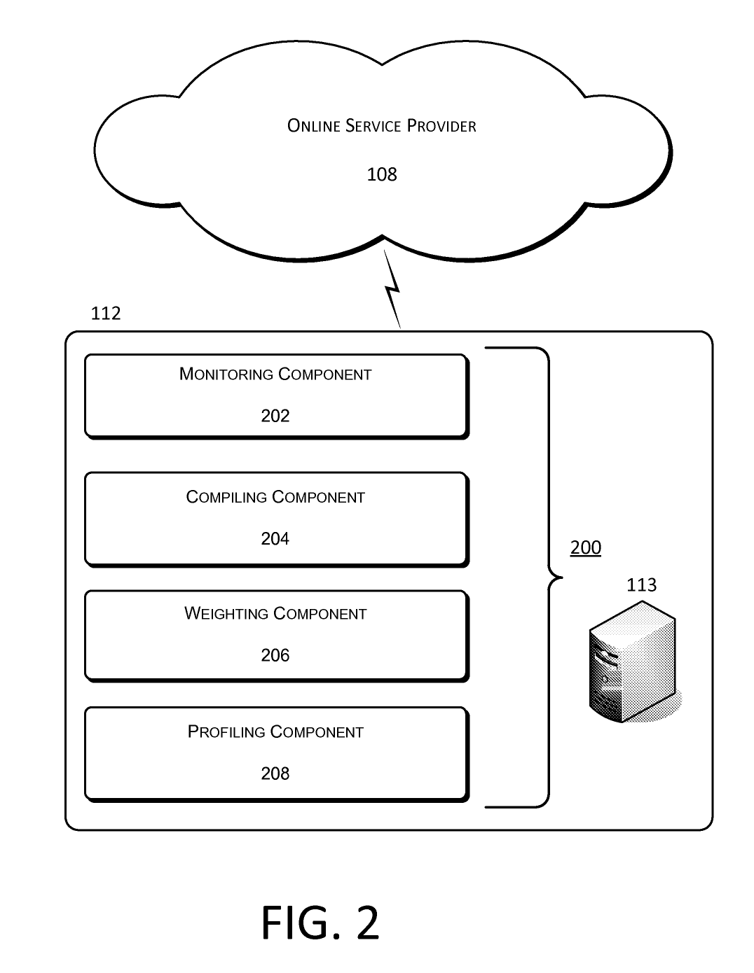

FIG. 2 shows the system of FIG. 1, which includes an example configuration 200 of monitoring entity 112 that is configured to implement social networking-based profiling, arranged in accordance with at least some embodiments described herein. As depicted, example configuration 200 of a platform that is hosted on a server 113 at or corresponding to monitoring entity 112, includes a monitoring component 202, a compiling component 204, a weighting component 206, and a profiling component 208. In FIG. 2, server 113 at or corresponding to monitoring entity 112 is depicted relative to online service provider 108, as in FIG. 1; however, this configuration is an example only, and is not intended to be limiting in any manner.

Monitoring component 202 may refer to a component or module that is configured, designed, and/or programmed to monitor the activity for any one of employees 102, particularly those in subset 104, on a service, e.g., social networking service, hosted by online service provider 108, to detect and collect instances of predetermined indicia. As set forth above, the indicia may include one or more keywords that are indicative of job-related performance, as gleaned from psychological profiles for subjects belonging to one or more of a particular, department, job title, job description, skill set, etc., particularly high achieving subjects, whether affiliated with Company X or not.

Compiling component 204 may refer to a component or module that is configured, designed, and/or programmed to compile the collected instances of the detected indicia occurring in the monitored activity of a respective one of employees 102, particularly those in subset 104. Compiling component 204 may be further configured, designed, and/or programmed to collate the compiled instances of the detected indicia according to various categorizations including those by which subset 104 is categorized.

Weighting component 206 may refer to a component or module that is configured, designed, and/or programmed to assign a ranking to respective ones of the compiled and/or collated indicia. A weight assigned to a respective one of the predetermined indicia may also be gleaned from psychological profiles for one or more of the categories that may be utilized to aggregate subset 104, or such a weighting may be implemented based on priorities established by an individual, internal or external to Company X, who has been given such authority for one of various reasons related to producing a telling profile.

Profiling component 208 may refer to a component or module that is configured, designed, and/or programmed to produce an optimal profile of a hypothetical employee for Company X corresponding to one or more of the categories by which subset 104 of employees 102 may be categorized. Further, or alternatively, profiling component 208 may be configured, designed, and/or programmed to produce a prioritized list of topics, questions, traits, by which job candidates or prospective employees are to be subjected.

Accordingly, for corporate human resources purposes, more efficient job descriptions may be produced and a more efficient employee search process may be implemented. That is, by appropriately collating and weighting detected instances of the predetermined indicia in the activity for one or more of employees 102, particularly those within subset 104, a generalized view of an optimal job candidate may be produced and therefore a vetting process for such a job candidate may be more efficiently executed. Such a job candidate would have one or more of the character and/or personality traits revealed by the monitored activity for the subject employees 102.

Thus, FIG. 2 show an example configuration of monitoring entity 112 by which one or more embodiments of social networking-based profiling may be implemented.

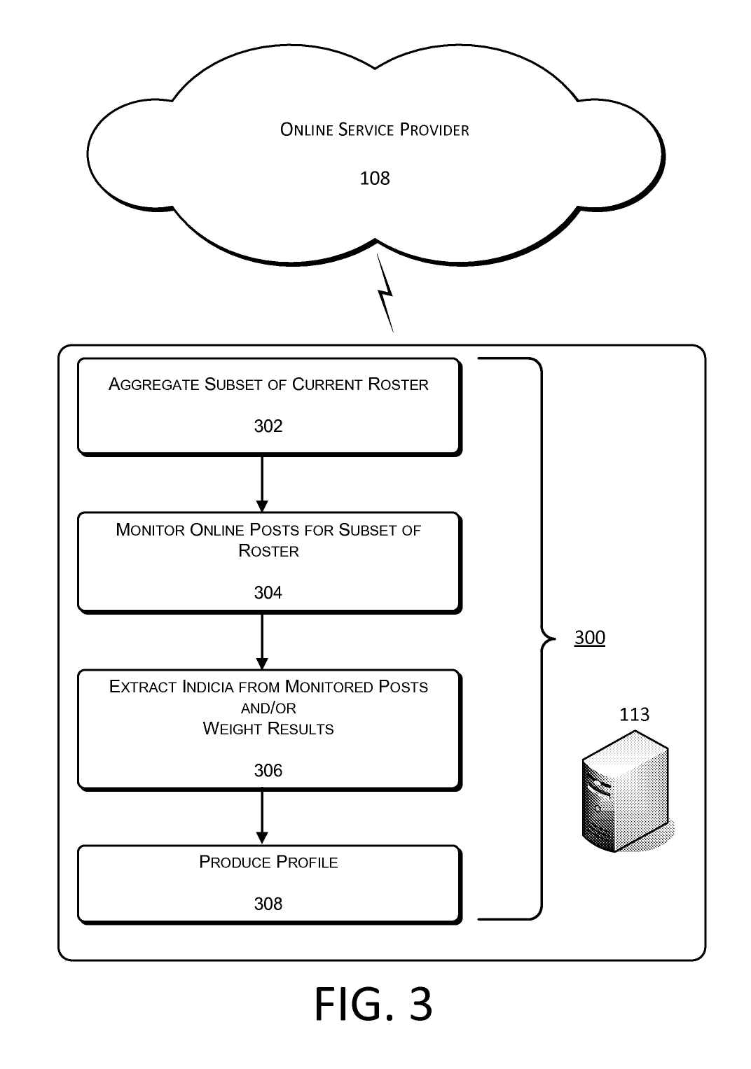

FIG. 3 shows system 100, which includes an example configuration of a processing flow of operations for social networking-based profiling implemented by, at least, a monitoring entity, arranged in accordance with at least some embodiments described herein. As depicted, processing flow 300 may include sub-processes executed on or by server 113 on or corresponding to monitoring entity 112. However, processing flow 300 is not limited to such components, as obvious modifications may be made by re-ordering two or more of the sub-processes described here, eliminating at least one of the sub-processes, adding further sub-processes, substituting components, or even having various components assuming sub-processing roles accorded to other components in the following description. Processing flow 300 may include various operations, functions, or actions as illustrated by one or more of blocks 302, 304, 306, and/or 308. Processing may begin at block 302.

Block 302 (Aggregate Subset of Current Roster) may refer to monitoring entity 112, by any one or more of components 202, 204, 206, and 208, or any other component or module therein, aggregating at least a subset 104 of a listing of employees 102 into at least one of plural categories. As set forth above, subset 104 of employees 102 may be aggregated on the basis of one or more categorizations that include, but certainly are not limited, to: participation on one or more particular online services, e.g., social networking services; department within Company X; job title within Company X; job description within Company X; skill set utilized at Company X; years of employment at Company X; etc. Processing may continue from block 302 to block 304.

Block 304 (Monitor Online Activity for Subset of Roster) may refer to monitoring component 202 monitoring the activity for any one of employees 102, particularly those in subset 104, on the service, e.g., social networking service, hosted by online service provider 108, to detect and collect instances of predetermined indicia occurring in the activity of a respective one of employees 102. The indicia may include one or more keywords that are indicative of job-related performance, as gleaned from psychological profiles for subjects belonging to one or more of a particular, department, job title, job description, skill set, etc.

Block 306 (Extract Indicia from Monitored Posts and/or Weight Results) may refer to compiling component 204 compiling the collected instances of the detected indicia occurring in the monitored activity of a respective one of employees 102, and collating the compiled instances of the detected indicia according to various categorizations including those by which subset 104 is categorized. Further, block 306 may refer to weighting component 206 assigning a ranking to respective ones of the compiled and/or collated indicia, thus assigning priories established by an individual, internal or external to Company X, who has been given such authority for one of various reasons related to producing a telling profile.

Block 308 (Produce Profile) may refer to profiling component 208 generating an optimal profile of a hypothetical employee for Company X corresponding to one or more of the categories by which subset 104 of employees 102 may be categorized. In addition to, or alternatively, block 308 may including profiling component 208 producing a prioritized list of topics, questions, traits, by which job candidates or prospective employees are to be subjected during the candidate vetting processing.

Accordingly, by processing flow 300 in FIG. 3, more efficient job descriptions may be produced and a more efficient employee search process may be implemented.

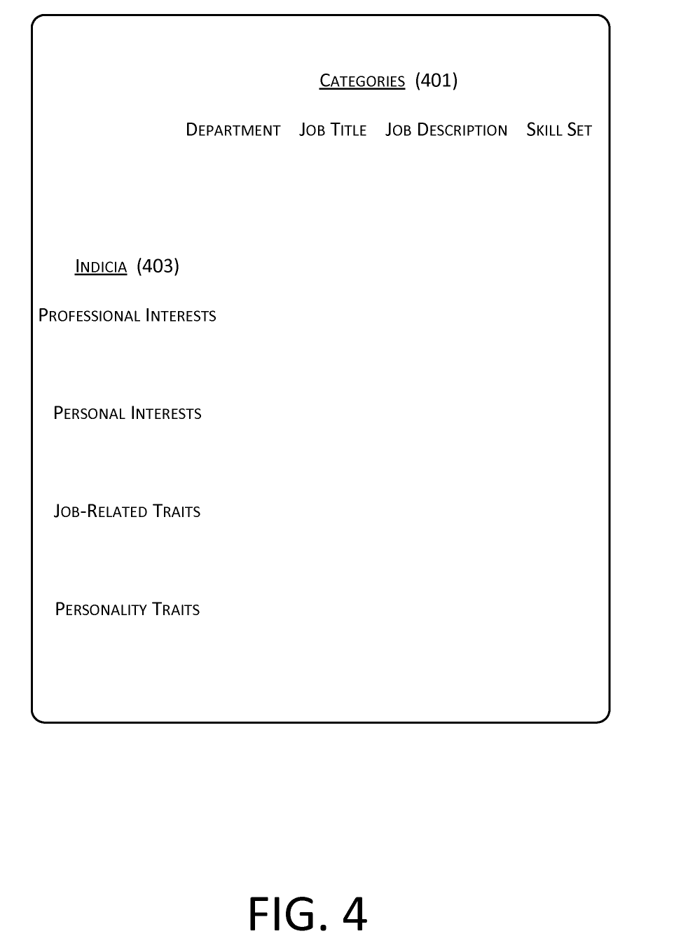

FIG. 4 shows an example configuration of a profile resulting from at least some of the embodiments of social networking-based profiling described herein. As depicted, profile 114 may include a listing 401 of categories by which employees 102 may be grouped and a listing of predetermined indicia 403.

FIG. 4 shows a mere sample profile 114 that shows a cross-listing of predetermined categories and predetermined indicia that may be deemed to be insightful to determining commonality among highly effective employees, thus enabling Company X to profile its top employees and to implement a methodology for finding future employees with similar traits and characteristics.

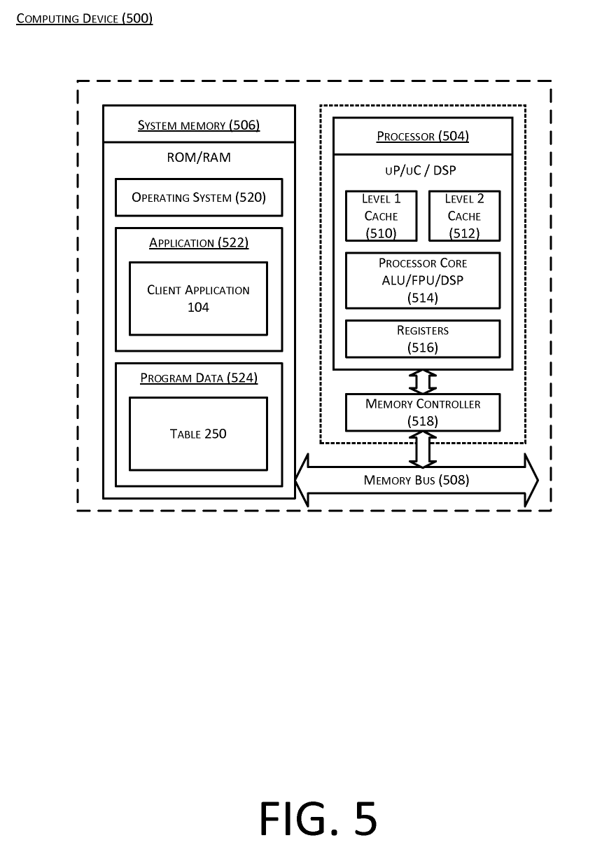

FIG. 5 shows a block diagram illustrating an example computing device 500 by which various example solutions described herein may be implemented, arranged in accordance with at least some embodiments described herein.

More particularly, FIG. 5 shows an illustrative computing embodiment, in which any of the processes and sub-processes described herein may be implemented as computer-readable instructions stored on a computer-readable medium. The computer-readable instructions may, for example, be executed by a processor of a device, as referenced herein, having a network element and/or any other device corresponding thereto, particularly as applicable to applications and/or programs described above corresponding to the configuration 100 for social networking-based profiling.

In a very basic configuration, a computing device 500 may typically include one or more processors 504 and a system memory 506. A memory bus 508 may be used for communicating between processor 504 and system memory 506.

Depending on the desired configuration, processor 504 may be of any type including but not limited to a microprocessor (μP), a microcontroller (μC), a digital signal processor (DSP), or any combination thereof.

Depending on the desired configuration, system memory 506 may be of any type including but not limited to volatile memory (such as RAM), non-volatile memory (such as ROM, flash memory, etc.) or any combination thereof. System memory 506 may include an operating system 520, one or more applications 522, and program data 524.

Application 522 may be configured to transmit or receive identification information pertaining to a client device corresponding to any one of employees 102 or a server corresponding to online service provider 108 to verify or validate identifying data, and transmit device data as described previously with respect to FIGS. 1-3. Program data 524 may include a table 550, which may be useful for implementing actuation of appropriate components or modules as described herein.

System memory 506 is an example of computer storage media. Computer storage media may include, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 500. Any such computer storage media may be part of computing device 500.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein may be implemented, e.g., hardware, software, and/or firmware, and that the preferred vehicle may vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes for system configuration 100 via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers, e.g., as one or more programs running on one or more computer systems, as one or more programs running on one or more processors, e.g., as one or more programs running on one or more microprocessors, as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors, e.g., feedback for sensing position and/or velocity; control motors for moving and/or adjusting components and/or quantities. A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Lastly, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A computer-readable medium storing computer-executable instructions that, when executed, cause one or more processors to:
aggregate at least a subset of a listing of current employees into at least one of plural categories;
scan online activity for one or more of the current employees to an online service to detect instances of predetermined indicia; and
collect the detected instances of the predetermined indicia into a profile for a prospective employee.

2. The computer-readable medium of claim 1, wherein the computer-readable medium is hosted on a corporate server.

3. The computer-readable medium of claim 1, wherein the subset of the listing of current employees include current employees who subscribe to the online service.

4. The computer-readable medium of claim 1, wherein the plural categories include department, job title, job description, and skill set.

5. The computer-readable medium of claim 1, wherein the online service includes a social networking service.

6. The computer-readable medium of claim 1, wherein the predetermined indicia include one or more keywords indicative of job-related performance.

7. The computer-readable medium of claim 1, wherein the predetermined indicia include one or more keywords indicative of a particular character trait.

8. The computer-readable medium of claim 1, wherein the predetermined indicia are gleaned from psychological profiles of subjects belonging to one or more of a particular department, job title, job description, and skill set.

9. The computer-readable medium of claim 1, wherein the profile for the prospective employee includes one or more questions pertaining to each of the compiled predetermined indicia.

10. The computer-readable medium of claim 8, wherein the predetermined indicia included in the profile for the prospective employee are weighted for significance.

11. A computer-readable medium storing computer-executable components, comprising:
a monitoring component that is configured to monitor activity on a social networking service for a subscribing participant to record instances of predetermined indicia;
a compiling component that is configured to compile the recorded instances of the predetermined indicia into respective categories;
a weighting component that is configured to assign a ranking to respective ones of the compiled indicia as the respective indicia respectively correspond to predetermined categories; and
a profiling component that is configured to gather the weighted indicia into a profile for at least one of the predetermined categories, for evaluation of prospective candidates.

12. The computer-readable medium of claim 11, wherein the subscribing participant is a current employee of a particular entity.

13. The computer-readable medium of claim 11, wherein the predetermined indicia are psychological indicators determined by a psychological profile to be pertinent to performance related to the predetermined categories.

14. The computer-readable medium of claim 11, wherein the ranking of the compiled indicia are weighted relative to predetermined significance pertaining to one or more of the predetermined categories.

15. The computer-readable medium of claim 11, wherein the predetermined categories include one or more of a department, job title, job description, or skill set for the subscribing participant.

16. The computer-readable medium of claim 11, wherein the profiling component is further configured to generate a questionnaire for the prospective employees that includes questions that respectively include one or more of the weighted indicia.

17. A method, comprising:
monitoring activity on a social networking service by current employees who meet threshold performance standards;
compiling indicia that are common to the monitored activity for a threshold number of the current employees on the social networking service during a predetermined time frame;
weighting the compiled indicia in accordance with a standard psychological profile for one or more categories pertaining to the current employees; and
generating a profile for a prospective employee in accordance with the weighted indicia.

18. The method of claim 17, wherein the predetermined time frame is common to a time of employment for the current employees.

19. The method of claim 17, wherein the compiled indicia are keywords and the one or more categories includes a department, a job title, a job description, and a skill set.

20. The method of claim 17, wherein the generated profile includes weighted questions for the prospective employee.
